(19) United States
(12) Patent Application Publication
(10) Pub. No.: US 2026/0253984 A1
(43) Pub. Date: Aug. 27, 2026

(54) Thermal Management Device for Battery Energy Storage Systems

(71) Applicant: Bergstrom, Inc., Rockford, IL (US)

(72) Inventors: Tingzhou WU, Rockford, IL (US); Ping RAO, Shanghai (CN); Jianye HUANG, Wuxi Jiangsu (CN)

(21) Appl. No.: 19/547,041

(22) Filed: Feb. 23, 2026

Related U.S. Application Data
(60) Provisional application No. 63/761,842, filed on Feb. 21, 2025.

(51) Int. Cl. H01M 10/613; H01M 10/637; H01M 10/6568; H01M 10/6569

(52) U.S. Cl. CPC H01M 10/613; H01M 10/637; H01M 10/6568; H01M 10/6569

(57) ABSTRACT

This disclosure regards a thermal management device with integrated refrigeration and cooling capabilities. The device includes an enclosure, which contains a refrigerant loop, a coolant loop, and a refrigerant-loop HX configured to transfer heat from a liquid coolant in the coolant loop to a fluid refrigerant in the refrigerant loop. The refrigerant loop includes a compressor, which is fluidically coupled to a shared HX; the shared HX, which is fluidically coupled to the refrigerant-loop HX; and the refrigerant-loop HX, which is fluidically coupled to the compressor. The coolant loop includes a coolant-loop HX, which is fluidically coupled to a coolant pump and configured to transfer heat from a battery energy storage system to the liquid coolant; the coolant pump, which is fluidically coupled to the refrigerant-loop HX; and the refrigerant-loop HX, which is fluidically coupled to the coolant-loop HX.

### RELATED APPLICATIONS

This application claims priority to the following U.S. Provisional Patent Application No. 63/761,842, filed Feb. 21, 2025, entitled “THERMAL MANAGEMENT DEVICE FOR BATTERY ENERGY STORAGE SYSTEMS”, which is hereby incorporated by reference in its entirety.

### TECHNICAL FIELD

The present disclosure relates, generally, to cooling technologies and, more specifically, to integrated air-cooled chiller and HVAC for use with battery energy storage systems.

### BACKGROUND

Battery energy storage systems play a vital role in many electrical grids. These systems store excess energy generated during peak production times and then release energy during low production times or periods of high-demand. They are especially important in grids that rely on intermittent, renewable energy sources—providing power when it might otherwise be unavailable (e.g., during evenings for solar-powered systems).

These battery energy storage systems can generate significant amounts of heat, however, which is of particular concern where lithium-ion batteries are used for storage. (Lithium is a flammable substance.) Accordingly, battery energy storage systems commonly include cooling systems for ensuring they do not overheat while still operating efficiently.

### SUMMARY

Current cooling solutions employ separate air-cooled chillers and heating, ventilation, and air conditioning (HVAC) units. Together, these devices provide battery energy storage systems with battery cooling and climate control capabilities; however, each device requires its own refrigeration loop. The present disclosure seeks to resolve that redundancy and further innovate on existing technologies.

This disclosure regards a system configured for handling component cooling and climate control for a battery energy storage system. The system relies on one or more of a single refrigeration loop, a secondary refrigerant loop, and/or an air handling loop and is therefore likely to be more efficient than state-of-the-art systems. Thermal management devices employing this system can replace modern chillers and HVAC units in many instances, requiring only a single installation and at potentially lower prices. Moreover, certain embodiments of the subject technology may be more efficient than current technologies because said embodiments require only a single condenser and condensing fan.

Example embodiments include the following:

A Thermal Management Device with Integrated Refrigeration and Cooling Capabilities. The device includes a refrigerant loop, a coolant loop, and an air handling loop. The refrigerant loop contains a fluid refrigerant, the coolant loop contains a liquid coolant, and the air handling loop is configured to transfer heat from air to the fluid refrigerant. The refrigerant loop includes a compressor, two refrigerant-loop heat exchangers (HXs) for a chiller and an HVAC, respectively, and a shared heat exchanger (HX) for a condenser. The compressor is fluidically coupled to the shared HX, the shared HX is fluidically coupled to the refrigerant-loop HX, and the refrigerant-loop HX is fluidically coupled to the compressor. The coolant loop includes a coolant-loop HX, a coolant pump, and the refrigerant-loop HX. The coolant-loop HX is configured to transfer heat from a battery energy storage system to the liquid coolant. Additionally, the coolant-loop HX is fluidically coupled to the coolant pump, the coolant pump is fluidically coupled to the refrigerant-loop HX, and the refrigerant-loop HX is fluidically coupled to the coolant-loop HX.

A Method of Manufacturing a Thermal Management Device with Integrated Refrigeration and Cooling Capabilities. The method includes providing a compressor, two refrigerant-loop HXs, a coolant-loop HX, a coolant pump, and a shared HX. The method also includes forming a refrigerant loop by fluidically coupling the compressor to the shared HX, fluidically coupling the shared HX to the refrigerant-loop HX, and fluidically coupling the refrigerant-loop HX to the compressor. Additionally, the method includes forming a coolant loop by fluidically coupling the coolant-loop HX to the coolant pump, fluidically coupling the coolant pump to the refrigerant-loop HX, and fluidically coupling the refrigerant-loop HX to the coolant-loop HX. Further, the method includes filling the refrigerant loop with a fluid refrigerant and the coolant loop with a liquid coolant. Note, the coolant-loop HX is configured to transfer heat from a battery energy storage system to the liquid coolant. Also note, the refrigerant-loop HX is configured to transfer heat from the liquid coolant to the fluid refrigerant.

A Method of Operating a Thermal Management Device with Integrated Refrigeration and Cooling Capabilities. The method includes receiving sensor data from first and second sensors. The sensor data is indicative of a thermal state of a battery energy storage system cooled by a thermal management device. The thermal management device includes a refrigerant loop containing a fluid refrigerant, a coolant loop containing a liquid coolant, and a shared HX configured to transfer heat from the fluid refrigerant to air. The method also includes adjusting operation of a component of the refrigerant loop or the coolant loop based on the sensor data from the first and second sensors. Note, the refrigerant loop includes a compressor, two refrigerant-loop HXs, and the shared HX. In the refrigerant loop, the compressor is fluidically coupled to the shared HX, the shared HX is fluidically coupled to the refrigerant-loop HX, and the refrigerant-loop HX is fluidically coupled to the compressor. Also note, the coolant-loop HX is fluidically coupled to the coolant pump, the coolant pump is fluidically coupled to the refrigerant-loop HX, and the refrigerant-loop HX is fluidically coupled to the coolant-loop HX.

Other configurations of the subject technology will be apparent to those skilled in the art from the detailed description below, which describes various configurations of the technology and illustrations thereof. This technology is capable of other and different configurations, and its several details are capable of modification in various other respects, all without departing from the scope of the subject technology. Thus, the Drawings and Detailed Description are presented as illustrative in nature and should not be construed as restricting the present disclosure.

### BRIEF DESCRIPTION OF THE DRAWINGS

For a better understanding of the present disclosure, reference should be made to the Detailed Description, below, in conjunction with the following drawings. Like reference numerals refer to corresponding parts throughout the figures and the description.

FIGS. 1A and 1B illustrate a thermal management device with integrated refrigeration and cooling capabilities, according to various aspects of the subject technology.

FIG. 2 illustrates a thermal management system for a thermal management device (e.g., device 100) with integrated refrigeration and cooling capabilities, according to various aspects of the subject technology.

FIG. 3A illustrates an example process for manufacturing a thermal management device and FIG. 3B illustrates an example process for operating a thermal management device, according to various aspects of the subject technology.

FIG. 4 illustrates example components of a controller of a thermal management device, according to various aspects of the subject technology.

### DETAILED DESCRIPTION

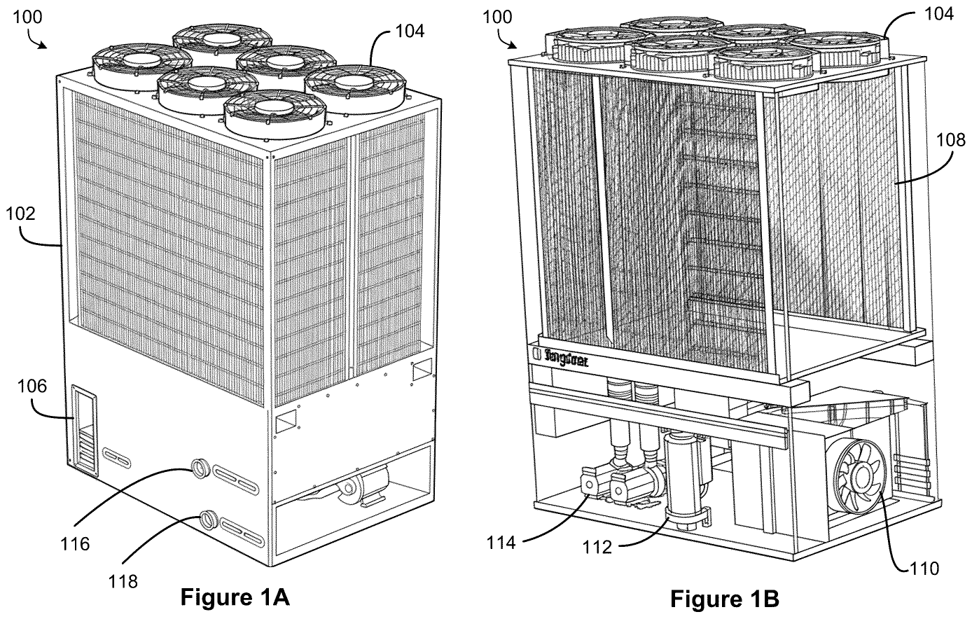

FIGS. 1A and 1B illustrate a thermal management device 100 with integrated refrigeration and cooling capabilities, according to various aspects of the subject technology. The device 100 is configured to perform the functionalities of both a chiller and an HVAC unit. Accordingly, it is capable of cooling batteries of a battery energy storage system and also controlling the climate of the air within the system and/or surrounding said batteries (e.g., within battery storage cabinets). The thermal management device 100 can thus replace less efficient cooling systems that require individual chillers and HVAC units.

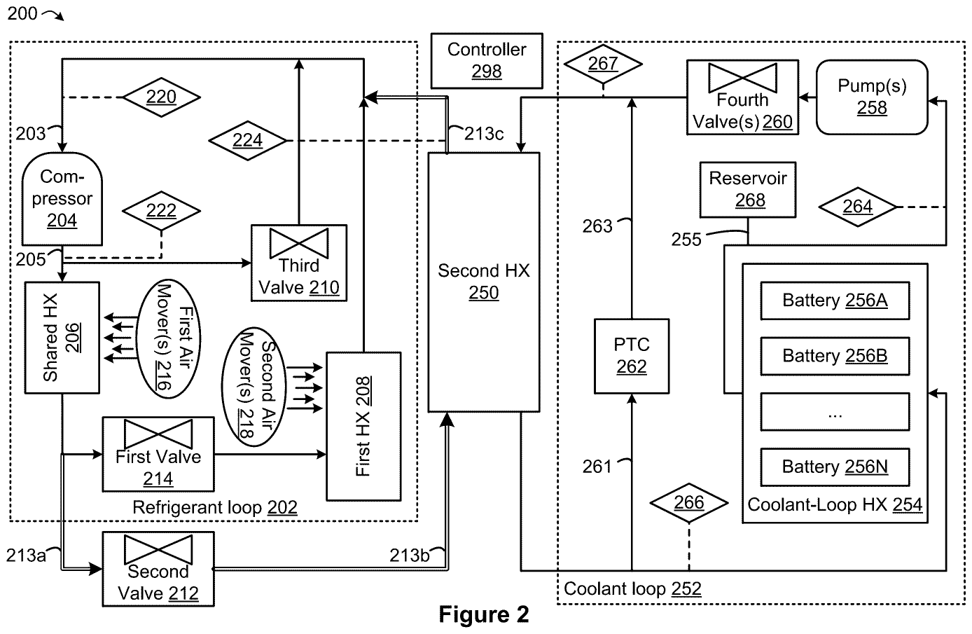

FIG. 1A offers a perspective view of the device's exterior, depicting the device's enclosure 102, condenser fans 104, and exhaust vent 106. The enclosure 102 also includes an HVAC vent 106, as well as an inlet 116 and an outlet 118 for coolant flow. The inlet 116 and outlet 118 allow the device 100 to be coupled to a heat exchanger (HX) configured to remove heat from batteries in a battery energy storage system, such as the coolant-loop HX 252 discussed below for FIG. 2.

The perspective view of FIG. 1B removes the enclosure 102 to show various internal components of the device 100, including a condenser 108, a blower 110, a compressor 112, and coolant pumps 114. These and other components of the thermal management device 100 are discussed in more detail below.

The HVAC portion of the device 100 can be used to condition the battery enclosure, controlling both air temperature and humidity when the battery storage system is idle or during a commissioning stage of the battery energy storage system (e.g., reducing auxiliary power requirements). During the battery charge and discharge cycle, the chiller can be used to maintain (e.g., cooling, heating) the temperature of battery cells in the battery energy storage system. In some embodiments, the HVAC is not used during charging and/or discharging of the batteries. For example, a controller (e.g., a processor) of the device 100 can be configured to operate only the chiller while the batteries are charging and/or discharging but operate the chiller and the HVAC while the batteries are not charging and/or discharging.

FIG. 2 illustrates a thermal management system for a thermal management device (e.g., device 100) with integrated refrigeration and cooling capabilities, according to various aspects of the subject technology. Though not pictured, one or more of the components of the thermal management system 200 can be contained within a single enclosure, such as the enclosure 102 described for FIGS. 1A and 1B. In some embodiments, each of the components is included in a single enclosure. Alternatively, in some embodiments, one or more components are not included in the single enclosure (e.g., HX 254 and batteries 256).

The thermal management system 200 includes a refrigerant loop 202, a coolant loop 252, and an air-handling loop (represented by at least refrigeration lines 213a-213c). In some embodiments, the refrigerant loop 202 is part of an HVAC system. The refrigerant loop 202 contains a fluid refrigerant, and the coolant loop 252 contains a liquid coolant. The refrigerant loop 202 and the coolant loop 252 are thermally coupled via a second HX (HX) 250. The refrigerant loop 202 and the air-handling loop have a shared HX 206 situated therebetween. The shared HX 206 is configured to transfer heat from the fluid refrigerant to air. In some embodiments, the thermal management system 200 includes a controller 298 electrically coupled to various components of the thermal management system 200.

The refrigerant loop 202 includes a compressor 204 fluidically coupled with the shared HX 206, the shared HX 206 fluidically coupled with a first valve 214, the first valve 214 fluidically coupled with a first HX 208, and the first HX 208 fluidically coupled with the compressor 204. In some embodiments, the compressor 204 can be a reciprocating compressor, a screw compressor, a scroll compressor, a centrifugal compressor, or any other type of compressor used in refrigeration loops or HVAC systems. In some embodiments, the first HX 208 is an evaporator (e.g., bare tube, falling film, finned, plate, shell tube, and film evaporators, etc.) and the first valve 214 is an expansion valve (e.g. thermostatic expansion valve, automatic expansion valve, electronic expansion valve, capillary tube, etc.). In some embodiments, the first HX 208 includes and/or is coupled with an APTC heater. In some embodiments, the shared HX 206 is a condenser (e.g., air-cooled condenser, water-cooled condenser, combination of air-cooled and water-cooled condensers, etc.). The shared HX 206 is shared between, at least, the refrigerant loop 202 and the air-handling loop. Each of the compressor 204, the shared HX 206, the first valve 214, and the first HX 208 are fluidically coupled via refrigerant lines (represented as continuous lines) as shown in the FIG. 2.

The refrigerant loop 202 includes a second valve 212 coupled with the shared HX 206. The second valve 212 fluidically couples a portion of the refrigerant loop 202 to the air-handling loop (represented by double-lined arrows). In particular, the shared HX 206 is fluidically coupled with the second valve 212 (e.g., via a first refrigerant line 213a), the second valve 212 is fluidically coupled with the second HX 250 (e.g., via a second refrigerant line 213b), and the second HX 250 is fluidically coupled with the compressor 204 (e.g., back to the refrigerant loop 202 via a third refrigerant line 213c). The second valve 212 is an expansion valve analogous to the first valve 214. In some embodiments, the second HX 250 transfers heat from air to the (liquid) refrigerant. In some embodiments, the second HX 250 operates as an evaporator. In some embodiments, the second HX 250 is a cold plate (e.g., in a two-phase cooling system). The air-handling loop allows the refrigerant loop 202 (e.g., which can include an HVAC system) to utilize (or share) a chiller condenser (e.g., the shared HX 206) of the coolant loop 252, which reduces the need in a separate HVAC system, reduces material costs, and improves efficiency gains in terms of coefficient of performance (e.g., since a chiller condenser is larger in size than is typically found in standalone HVAC systems).

In some embodiments, the refrigerant loop 202 includes a third valve 210. The third valve 210 can be configured as a bypass valve. For example, the third valve 210 can be fluidically coupled between an outlet 205 of the compressor 204 and an inlet 203 of the compressor 204 and be configures as a hot-gas bypass valve (which can be used to regulate the flow of hot gas into an evaporator to prevent freezing).

The first valve 214, the second valve 212, and the third valve 210 can be used for capacity control or other purposes. The first valve 214 and the second valve 212 can be used to control a liquid refrigerant flow. The third valve 210 can be used to control a gas refrigerant flow.

Additionally, the refrigerant loop 202 includes one or more first air movers 216 and one or more second air movers 218 (e.g., fans, blowers, etc.). The first air movers 216 and/or second air movers 218 can be used for moving air across the shared HX 206 and/or first HX 208, respectively. In some embodiments, the first air movers 216 are used to transfers heat from the refrigerant to the air. In some embodiments, the first air movers 216 are used to move conditioned air through a compartment or other space and/or facilitate the transfer of heat from the air to the refrigerant.

Further, the refrigerant loop 202 includes sensors 220 and 222 coupled at various positions around the refrigerant loop 202 and the air-handling loop includes sensor(s) 224 coupled at various positions around the air-handling loop. The sensors 220, 222, and 224 are configured to collect sensor data (e.g., temperature data, pressure data, flow speed data) indicative of a thermal state of the refrigerant loop 202 and/or air-handling loop. In some embodiments, sensor data from the sensors 220, 222, and 224 is used to adjust an operating speed of one or more components of the refrigerant loop 202 (e.g., compressor 204, first and second air movers 216 and 218, etc.) and/or the coolant loop 252 (e.g., coolant pumps 258), and/or control the first, second, and third valves 214, 212, and 210 and/or a positive temperature coefficient heater (PTC) 262. In some embodiments, sensor data from the sensors 220, 222, and 224 is used to determine a charge level of the refrigerant loop 202 and/or air-handling loop. The sensors 220, 222, and 224 are non-limiting, and any number of sensors can be included in the refrigerant loop 202 and/or air-handling loop and/or disposed at different locations.

Although the refrigerant loop 202 includes the shared HX 206 and first HX 208 at particular locations, in alternate embodiments, the shared HX 206 206 and first HX 208 can be disposed at different locations and/or different types of HX can be used (e.g., the shared HX 206 can be an evaporator and the first HX 208 can be a condenser). For example, in embodiments that permit reverse operation of the refrigerant loop 202 (e.g., through the use of heat pumps and/or through flow control via one or more valves), one or more components of the refrigerant loop 202 may be disposed at different locations to perform the functions refrigerant loop 202.

The second HX 250 is also thermally coupled (and/or makes part of) the coolant loop 252. In particular, the coolant loop 252 includes one or more coolant pumps 258 (e.g., pumps 114; FIG. 1B) fluidically coupled with one or more fourth valves 260, the one or more fourth valve 260 are fluidically coupled with the second HX 250, the second HX 250 is fluidically coupled with a coolant-loop HX 254, and the coolant-loop HX 254 is fluidically coupled with the one or more coolant pumps 258. In some embodiments, the coolant loop 252 includes a PTC 262 that is fluidically coupled an outlet of the second HX 250 with an inlet of the second HX 250 (e.g., represented by coolant lines 261 and 263).. In some embodiments, the coolant loop 252 includes a reservoir 268 fluidically coupled to an outlet of the coolant-loop HX 254 (e.g., represented by coolant line 255). Each of the coolant pumps 258, the fourth valves 260, the second HX 250, the PTC 262, the reservoir 268, and the coolant-loop HX 254 are fluidically coupled via coolant lines (represented as continuous lines) as shown in the FIG. 2.

The coolant-loop HX 254 is thermally coupled to one or more batteries 256. The coolant-loop HX 254 is configured to transfer heat from the one or more batteries 256 to the liquid coolant. In some embodiments, the coolant-loop HX 254 is a battery rack (e.g., battery storage cabinet), part of one or more battery racks, and/or thermally coupled with one or more battery racks. For example, the coolant-loop HX 254 receives a liquid coolant from the second HX 250 and, as the liquid coolant passes through the coolant-loop HX 254, the coolant-loop HX 254 transfers heat from the one or more batteries 256 to the liquid coolant. Although FIG. 2 shows the coolant-loop HX 254 thermally coupled with batteries 256, the coolant-loop HX 254 to any electronics components (e.g., computers, servers, processors, etc.) for thermal management. In some embodiments, the coolant-loop HX 254 is fluidically coupled with the reservoir 268. The reservoir 268 stores liquid coolant for the coolant loop 252. In some embodiments, the reservoir 268 operates as a surge tank that allows for the expansion and contraction of liquid coolant as it heats up and cools and/or that absorbs pressure surges and provides additional liquid coolant during drops in pressure.

The coolant pumps 258 can be centrifugal pumps, diaphragm pumps, gear pumps, peristaltic pumps, submersible pumps, lobe pumps, and/or other types of pumps. The coolant pumps 258 are configured to pump the liquid coolant throughout the coolant loop 252. Any number of coolant pumps 258 can be used based on the design needs. For example, in some embodiments, the coolant loop 252 includes a single coolant pumps 258. Alternatively, in some embodiments, the coolant loop 252 includes a plurality of coolant pumps 258. In some embodiments, multiple coolant pumps 258 are fluidically coupled in parallel. Although not shown, in some embodiments, an inlet of the coolant pumps 258 is fluidically coupled with a strainer (e.g., a filter that removes debris from the coolant loop 252) and/or drainage valve (e.g., for removing liquid coolant from the coolant loop 252).

These coolant pumps 258 are fluidically coupled with the fourth valves 260. In some embodiments, each coolant pumps 258 is fluidically coupled with respective fourth valves 260. In some embodiments, the fourth valves 260 are reflux valves 260 that are configured to prevent backflow of the liquid coolant (e.g., from the fourth valves 260 back towards the coolant pump 258). The one or more fourth valves 260 are fluidically coupled with the second HX 250.

The second HX 250 transfers heat from the liquid coolant in the coolant loop 252 to the fluid refrigerant contained in the air-handling loop (which is fluidically coupled with the refrigerant loop 202).

The PTC 262 is configured to heat the liquid coolant when the ambient temperature is low, such that the one or more batteries 256A-256N are kept within the proper temperature range.

The coolant loop 252 also includes one or more sensors 264, 266, and 267. In some embodiments, a first coolant-loop sensor 264 is disposed downstream from the coolant-loop HX 254 (e.g., between the coolant-loop HX 254 and the one or more coolant pumps 258). In some embodiments, a second coolant-loop sensor 266 is disposed upstream of the coolant-loop HX 254 (e.g., between the second HX 250 and coolant-loop HX 254). In some embodiments, a third coolant-loop sensor 267 is disposed near the second HX 250 (e.g., adjacent to the thermally coupled portions of the coolant loop 252, the refrigerant loop 202, and/or air-handling loop). Each of these sensors 264, 266 and 267 is configured to collect sensor data (e.g., temperature data, pressure data, flow speed data) regarding the coolant loop 252, the liquid coolant contained therein, or the air surrounding the loops 202 and 252. For example, the first and second coolant-loop sensors 264 and 266 can include temperature sensors configured to collect temperature data indicative of the temperature of the coolant. Additionally, or alternatively, the first and second first coolant-loop sensors 264 and 266 may include pressure sensors configured to collect pressure data indicative of the pressure of the coolant. Such data can be used, for instance, to determine the temperature of the batteries 256 or the effectiveness of the coolant-loop 252. As yet another example, the third coolant-loop sensor 267 can include a temperature and/or humidity sensor configured to collect temperature and/or humidity data indicative of a temperature and/or humidity of air surrounding the refrigerant and coolant loops 202 and 252.

In some embodiments, sensor data from the first, second, and third coolant-loop sensors 264, 266, and 267 is used to adjust an operating speed of one or more components of the coolant loop 252 (e.g., coolant pumps 258) and/or the refrigerant loop 202 (e.g., compressor 204, first and second air movers 216 and 218, etc.), and/or control the first, second, and third valves 214, 212, and 210 and/or the PTC 262. The first, second, and third coolant-loop sensors 264, 266, and 267 are non-limiting, and any number of sensors can be included in the coolant loop 252 and/or disposed at different locations.

One or more components of the thermal management system 200 are electrically or communicatively coupled to a controller 298. For example, the sensors 220, 222, 224, 264, 266, and 267 can be configured to transmit sensor data (e.g., temperature, pressure, or flow speed data) to the controller 298. The controller 298 can then use this data to determine whether operation of other components of the thermal management system 200 should be adjusted—such as the first and second air movers 216 and 218, the compressor 204, the pump(s) 258, and so on.

In some embodiments, the controller 298 is configured to selectively open or close one or more of the valves 210, 212, and 214 based on sensor data from one or more of the sensors 220, 222, 224, 264, 266, and 267. For instance, if the controller determines based on sensor data (e.g., data from sensor 267) that a specific humidity of air around the thermal management device 100 exceeds a predetermined threshold, the controller 298 can open or close the first valve 214 fluidically coupled to the first HX 208 to control the humidity accordingly.

Similarly, in some embodiments, the controller 298 is configured to adjust operation (e.g., an operating speed) of the compressor 204, one or more of the first and second air movers 216 and 218, or the one or more coolant pumps 258 based on sensor data. For example, if the controller 298 determines based on sensor data (e.g., data from coolant-loop sensors 264 and 266) that a temperature associated with the coolant-loop HX 254 exceeds a predetermined threshold, the controller 298 can increase an operating speed of the one or more coolant pumps 258 to attempt to decrease the temperature of the coolant-loop HX 254 (and the thermally coupled electronics components).

The controller 298 can also be configured to activate and/or deactivate the refrigerant loop 202, the air-handling loop, and/or the coolant loop 252 based on whether the batteries 256 are charging, discharging, or neither charging nor discharging. For instance, in some embodiments, the controller 298 maintains the temperature of the batteries 256 using only the coolant loop 252 during battery charge and/or discharge cycles (e.g., disabling the refrigerant loop 202). Similarly, in some embodiments, the controller 298 maintains the temperature of the batteries 256 using both the coolant loop 252 and the refrigerant loop 202 while the batteries are not charging and/or discharging.

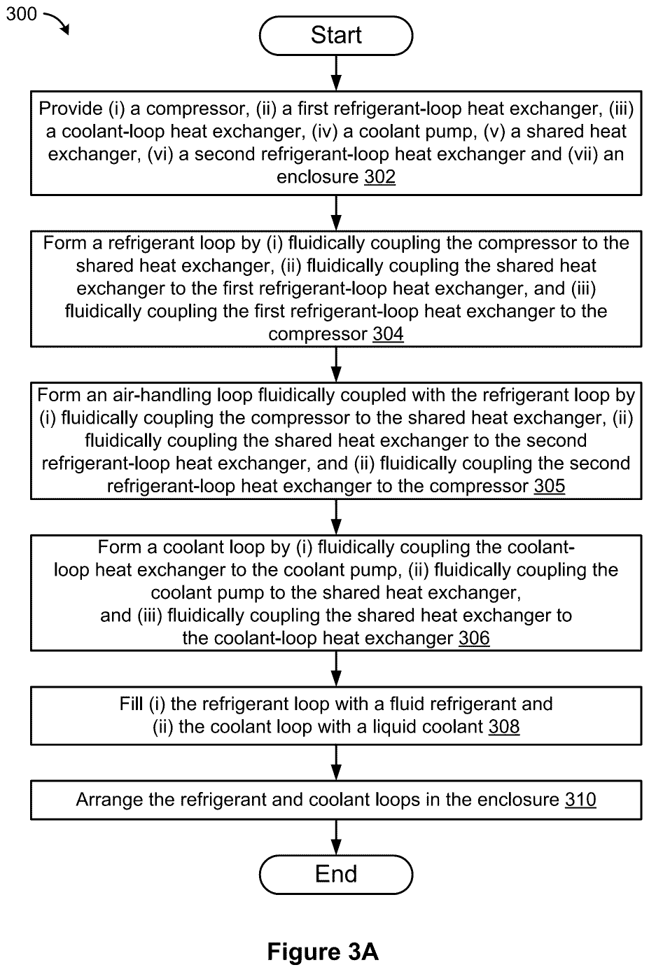

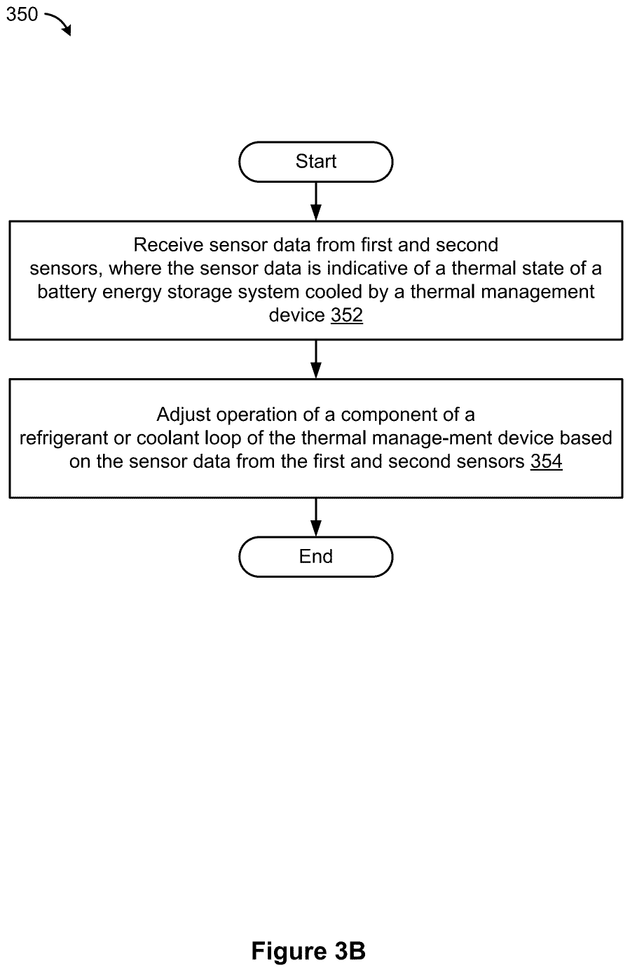

FIG. 3A illustrates an example process 300 for manufacturing a thermal management device (e.g., device 100), according to various aspects of the subject technology. This process 300 can be automated at least in part by one or more processors and machinery configured to perform one or more steps of the manufacturing process 300. The process 300 for manufacturing the device includes providing (302) a compressor 204 (FIG. 2), a shared HX 206 (such as a condenser), a coolant-loop HX 254, a coolant pump 258, a first refrigerant-loop HX (e.g., first HX 208), a second refrigerant-loop HX (e.g., second HX 250), and an enclosure 102 (e.g., FIGS. 1A and 1B).

The process 300 also includes forming (304) a refrigerant loop (e.g., refrigerant loop 202). Forming the refrigerant loop includes fluidically coupling the compressor 204 to the shared HX 206, fluidically coupling the shared HX 206 to the first refrigerant-loop HX, and fluidically coupling the first refrigerant-loop HX to the compressor 204. The process 300 further includes forming (305) an air-handling loop fluidically coupled with the refrigerant loop. Forming the air-handling loop includes fluidically coupling the compressor 204 to the shared HX 206, fluidically coupling the shared HX 206 to the second refrigerant-loop HX, and fluidically coupling the second refrigerant-loop HX to the compressor 204. Additionally, the process 300 includes forming (306) a coolant loop (e.g., coolant loop 252). Forming the coolant loop includes fluidically coupling the coolant-loop HX 254 to the coolant pump 258, fluidically coupling the coolant pump 258 to the second refrigerant-loop HX, and fluidically coupling the second refrigerant-loop HX to the coolant-loop HX 254.

Further, the process 300 includes filling (308) the refrigerant loop with a fluid refrigerant and the coolant loop with a liquid coolant. As a note, the coolant-loop HX is configured to transfer heat from a battery energy storage system (and/or other electronics) to the liquid coolant. Also note, the shared HX is configured to transfer heat from the fluid refrigerant to air and the second HX 250 transfers heat from air to the refrigerant and/or transfer heat from the liquid coolant in the coolant loop 252 to the refrigerant. Moreover, the process 300 includes arranging (310) the refrigerant and coolant loops in the enclosure. Alternatively, in some embodiments, the process 300 includes arranging in the enclosure the refrigerant loop, the shared HX, and a portion of the coolant loop (e.g., including the coolant pump but not the coolant-loop HX).

In some embodiments, the battery energy storage system includes one or more battery storage cabinets containing a plurality of batteries (e.g., batteries 256), and the coolant-loop HX is thermally coupled to the one or more battery storage cabinets such that the coolant-loop HX can transfer heat from the plurality of batteries to the liquid coolant in the coolant loop. Further, in some of these embodiments, the refrigerant loop is configured to control a climate (e.g., temperature, humidity) within the battery energy storage system (e.g., within the one or more battery storage cabinets).

In some embodiments, the method 300 further includes providing a first sensor, a second sensor, and a controller, and then coupling the first sensor to a first portion of the coolant loop between the refrigerant-loop HX (second HX 250) and the coolant-loop HX and coupling the second sensor to a second portion of the coolant loop between the coolant-loop HX and the coolant pump. Additionally, the method 300 can include configuring the controller to adjust operation of a component of the refrigerant loop or the coolant loop based on sensor data from the first and second sensors and indicative of a thermal state of the coolant-loop HX.

In some embodiments, the method 300 further includes configuring the controller to adjust the operation of the component based on a difference between first sensor data indicative of a temperature or pressure of the first portion of the coolant loop and second sensor data indicative of a temperature or pressure of the second portion of the coolant loop. The first sensor is configured to collect the first sensor data and the second sensor is configured to collect the second sensor data.

In some embodiments, the method 300 further includes providing a third sensor (e.g., sensor 267) configured to collect third sensor data indicative of a relative humidity within the battery energy storage system and configuring the controller to adjust operation of another component (e.g., coolant pump, compressor, air mover) of the refrigerant loop or the coolant loop based on the third sensor data.

In some embodiments, the controller adjusting the operation of the component includes adjusting an operating speed of the coolant pump, an operating speed of the compressor, or an operating speed of an air mover configured to blow air across a refrigerant-loop HX.

In some embodiments, the method 300 further includes providing a second refrigerant-loop HX and augmenting the refrigerant loop. Augmenting the refrigerant loop can involve fluidically coupling the second refrigerant-loop HX to the shared HX via an expansion valve, fluidically coupling the second refrigerant-loop HX to the first refrigerant-loop HX via another expansion valve, and fluidically coupling the first refrigerant-loop HX to the compressor.

In some embodiments, the refrigerant loop is arranged on a first side of the enclosure and the coolant loop (or a portion thereof, e.g., excluding the coolant-loop HX) is arranged on a second side of the enclosure opposite the first side (see, e.g., device 100 of FIGS. 1A and 1B).

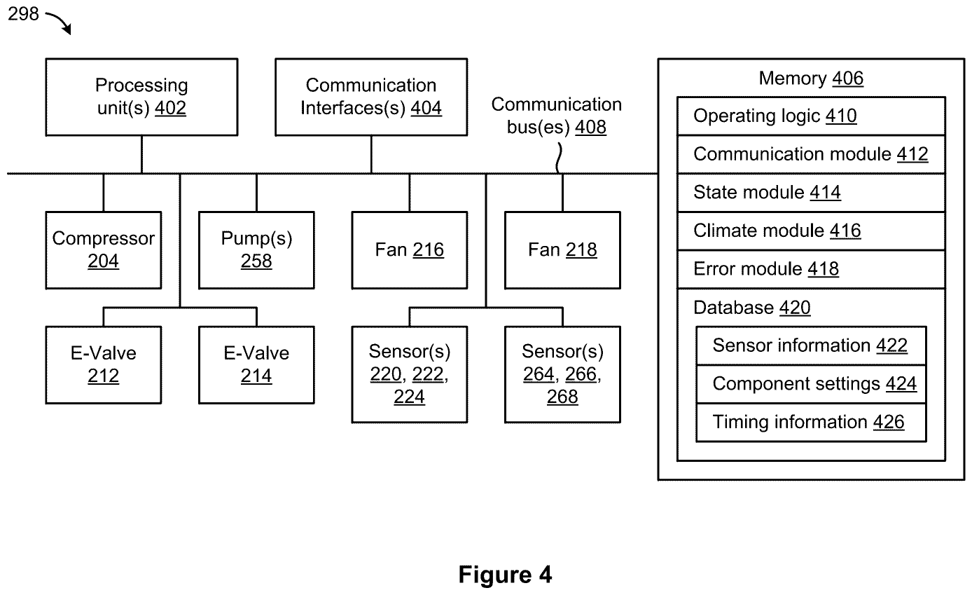

FIG. 3B illustrates an example process 350 for operating a thermal management device, according to various aspects of the subject technology. The operations of the process 350 can be executed at least in part by one or more of the devices discussed herein, such as the thermal management device controller 298 of FIGS. 2 and 4. In some embodiments, the process 350 is executed by a processor (e.g., one or more processing units 402) configured to execute instructions stored in a non-transitory, computer-readable medium (e.g., memory 406), where said instructions correspond to one or more of the process'operations.

The process 350 includes receiving (352) sensor data from a first sensor (e.g., sensor 264) and a second sensor (e.g., sensor 266). The sensor data is indicative of a thermal state of a battery energy storage system cooled by a thermal management device (e.g., device 100). For example, the sensor data may indicate temperatures or pressures of a liquid coolant before and after it flows through a HX (e.g., coolant-loop HX 254) , where the difference between the temperatures or pressures indicates a temperature of the HX.

The thermal management device includes at least a refrigerant loop (e.g., refrigerant loop 202) containing a fluid refrigerant, a coolant loop (e.g., coolant loop 252) containing a liquid coolant, and a refrigerant-loop HX (e.g., second HX 250) configured to transfer heat from the liquid coolant to the fluid refrigerant. The process also includes adjusting (354) operation of a component of the refrigerant loop (e.g., compressor 204, electronic valve 212 or 214, or fan 216 or 218) or of the coolant loop (e.g., one or more coolant pumps 258) based on the sensor data from the first and second sensors.

In some embodiments, the process 350 further includes maintaining a battery cell temperature using the coolant loop but not the refrigerant loop during battery charge and discharge cycles. For example, a controller can disable the refrigerant loop 202 (e.g., by turning off the compressor 204) while the batteries are charging and/or discharging. Additionally, in some embodiments, the process 350 includes maintaining a battery cell temperature using the coolant loop and the refrigerant loop outside of battery charge and discharge cycles.

In some embodiments, the first sensor is coupled to a first portion of the coolant loop between the refrigerant-loop HX (e.g., second HX 250) and the coolant-loop HX and is configured to collect first sensor data indicative of a temperature or pressure of the first portion of the loop. Further, the second sensor is coupled to a second portion of the coolant loop between the coolant-loop HX and the coolant pump and is configured to collect second sensor data indicative of a temperature or pressure of the second portion of the loop. In such embodiments, the process 350 can further include receiving first data from the first sensor, receiving second data from the second sensor, and adjusting the operation of the aforenoted component of the refrigerant loop or of the coolant loop based on a difference between the first sensor data and the second sensor data.

In some embodiments, the process 350 further includes receiving third sensor data from a third sensor (e.g., sensor 267) indicative of a relative humidity within the battery energy storage system and adjusting operation of another component of the refrigerant loop (e.g., compressor 204, electronic valve 212 or 214, or fan 216 or 218) or of the coolant loop (e.g., one or more coolant pumps 258) based on the third sensor data.

In some embodiments, adjusting the operation of the component includes adjusting an operating speed of the coolant pump, an operating speed of the compressor, or an operating speed of a fan configured to blow air across the refrigerant-loop HX.

FIG. 4 illustrates example components of a controller 298 of a thermal management device (e.g., device 100), according to various aspects of the subject technology. In the illustrated embodiment, the controller 298 includes one or more processing units 402 (e.g., CPUs, ASICs, FPGAs, microprocessors), one or more communication interfaces 404, memory 406, and one or more communication buses 408 for interconnecting at least these components.

In some embodiments, the controller 298 also includes one or more input devices (e.g., buttons) for receiving information from a user. Additionally, in some embodiments, the controller 298 includes one or more output devices (e.g., indicator lights, a sound card, a speaker, a display) for presenting information to a user. Similarly, in some embodiments, the controller 298 is communicatively coupled to an external display (e.g., a vehicle-mounted display, a display of a mobile device, or a display mounted to the controller 298). Further, in some embodiments, the controller 298 includes a location detection device (e.g., GPS or another geo-location receiver) for determining the location of the controller 298.

The controller 298 can be electrically or communicatively coupled to various other components of a thermal management device. In the illustrated embodiment, for instance, the controller 298 is coupled to a condenser 206, electronic valves 212 and 214, one or more coolant pumps 258, fans 216 and 218, and sensors 220, 222, 224, 264, 266, and 267. This allows the controller 298 to receive data from or control these other components in accordance with one or more programs executed by the controller. For example, the controller 298 may adjust an operating speed of the condenser 206 or the one or more coolant pumps 258 based on sensor data received from the sensors 220, 222, 224, 264, 266, or 267. As another example, the controller 298 may open or close the electronic valve 212 or 214 based on sensor data received from the sensors 220, 222, 224, 264, or 266.

The controller's one or more communication interfaces 404 include hardware capable of data communications using any of a variety of custom or standard wireless protocols (e.g., IEEE 802.15.4, Wi-Fi, ZigBee, 6LoWPAN, Thread, Z-Wave, Bluetooth Smart, ISAl00.lla, WirelessHART, MiWi), any of a variety of custom or standard wired protocols (e.g., Ethernet, HomePlug), or any other suitable communication protocol—including communication protocols not yet developed as of the filing date of the present disclosure.

The memory 406 includes high-speed random access memory, such as DRAM, SRAM, DDR SRAM, or other random access solid state memory devices. The memory 406 may also include non-volatile memory, such as one or more magnetic disk storage devices, one or more optical disk storage devices, one or more flash memory devices, or one or more other non-volatile solid state storage devices.

The memory 406 includes a non-transitory, computer-readable storage medium (CRSM). In some implementations, the memory 406 the following programs, modules, and data structures, or a subset or superset thereof (e.g., in the CRSM): (i) operating logic 410 including procedures for handling various system services and for performing hardware-dependent tasks; (ii) a communication module 412 for coupling to and communicating with other network devices via one or more networks (e.g., in conjunction with the one or more communication interfaces 404); (iii) a state module 414 for determining an operating state of the system (e.g., device 100) or for setting or adjusting the operating state of the system; (iv) a climate module 416 for managing climate-related operations of the system (e.g., temperature settings, humidity settings, air-quality settings, fan speeds, power settings) (e.g., in conjunction with state module 414); (v) an error module 418 for determining whether one or more error conditions are present, for conveying the one or more error conditions to a user of the system, or for initiating remedial action in response to the one or more error conditions; and (vi) a database 420.

The database includes at least: (i) sensor information 422 for storing and managing data received, detected, or transmitted by one or more sensors of the system (e.g., the sensors 220, 222, 224, 264, or 266); (ii) component settings 424 for storing and managing operational settings for one or more components of the system (e.g., a compressor 204, the condenser 206, an evaporator 208, the one or more pumps 258, a coolant-loop HX 254, batteries 256 stored in the HX); and (iii) timing information 426 for storing and managing timing information related to operation or testing of the system.

Each of the above identified elements (e.g., modules stored in the memory 406 of the controller 298) corresponds to a set of instructions for performing a function described herein. The above identified modules or programs (e.g., sets of instructions) need not be implemented as separate software programs, procedures, or modules, and thus various subsets of these modules may be combined or otherwise rearranged in various implementations. In some implementations, the memory 406, optionally, stores a subset of the modules and data structures identified above. Furthermore, the memory 406, optionally, stores additional modules and data structures not described above. For example, the memory 406 optionally stores a heating module (not shown) for managing heating operations of the system.

Illustrative Clauses. For further reference, example aspects of the present disclosure are included below as numbered clauses. These clauses are provided for illustrative purposes and are not intended to limit the subject technology.

Clause 1. A thermal management device with integrated refrigeration and cooling capabilities is disclosed. The thermal management device including a refrigerant loop containing a fluid refrigerant and including (i) a compressor (e.g., compressor 204; FIG. 2), (ii) a refrigerant-loop HX (e.g., second HX 250), and (iii) a shared HX (e.g., shared HX 206). The compressor is fluidically coupled to the shared HX, the shared HX is fluidically coupled to the refrigerant-loop HX; and the refrigerant-loop HX is fluidically coupled to the compressor. The thermal management device further includes a coolant loop including a liquid coolant and including (i) a coolant-loop HX (e.g., coolant-loop HX 254), (ii) a coolant pump (e.g., coolant pump 258), and (iii) the refrigerant-loop HX. The coolant-loop HX is fluidically coupled to the coolant pump and configured to transfer heat from a battery energy storage system to the liquid coolant. The coolant pump is fluidically coupled to the refrigerant-loop HX, and the refrigerant-loop HX is fluidically coupled to the coolant-loop HX. The thermal management device further includes an enclosure containing the refrigerant loop, the refrigerant-loop HX, and at least a portion of the coolant loop comprising the coolant pump. The refrigerant-loop HX is configured to transfer heat from the liquid coolant in the coolant loop to the fluid refrigerant in the refrigerant loop.

Clause 2. The thermal management device of clause 1, further including a controller configured to maintain a battery cell temperature using the coolant loop but not the refrigerant loop during battery charge and discharge cycles.

Clause 3. The thermal management device of either clause 1 or 2, further including a controller configured to maintain a battery cell temperature using the coolant loop and the refrigerant loop outside of battery charge and discharge cycles.

Clause 4. The thermal management device of any one of clauses 1 through 3, the battery energy storage system includes one or more battery storage cabinets containing a plurality of batteries; and the coolant-loop HX is thermally coupled to the one or more battery storage cabinets such that the coolant-loop HX can transfer heat from the plurality of batteries to the liquid coolant in the coolant loop.

Clause 5. The thermal management device of clause 4, the refrigerant loop is configured to control a climate within the one or more battery storage cabinets.

Clause 6. The thermal management device of any one of clauses 1 through 5, further including a first sensor coupled to a first portion of the coolant loop between the refrigerant-loop HX and the coolant-loop HX; a second sensor coupled to a second portion of the coolant loop between the coolant-loop HX and the coolant pump; and a controller configured to adjust operation of a component of the refrigerant loop or the coolant loop based on sensor data from the first and second sensors. The sensor data is indicative of a thermal state of the coolant-loop HX.

Clause 7. The thermal management device of clause 6, the first sensor is configured to collect first sensor data indicative of a temperature or pressure of the first portion of the coolant loop; the second sensor is configured to collect second sensor data indicative of a temperature or pressure of the second portion of the coolant loop; and the controller is configured to adjust the operation of the component based on a difference between the first sensor data and the second sensor data.

Clause 8. The thermal management device of either clause 6 or 7, further including a third sensor configured to collect third sensor data indicative of a relative humidity within the battery energy storage system; wherein the controller is configured to adjust operation of another component of the refrigerant loop or the coolant loop based on the third sensor data. The other component includes the coolant pump, the compressor, or a fan configured to blow air across the shared HX.

Clause 9. The thermal management device of any one of clauses 6 through 8, adjusting the operation of the component comprises adjusting an operating speed of the coolant pump, an operating speed of the compressor, or an operating speed of a fan configured to blow air across the shared HX.

Clause 10. The thermal management device of any one of clauses 1 through 9, the refrigerant loop further includes another refrigerant-loop HX (e.g., first HX 208). The refrigerant-loop HX (e.g., the second HX 250) is fluidically coupled to both: (i) the shared HX via an expansion valve, and (ii) the other refrigerant-loop HX via another expansion valve; and the other refrigerant-loop HX is fluidically coupled to the compressor.

Clause 11. The thermal management device of clause 10, the shared HX is a condenser; and the other refrigerant-loop HX is an evaporator.

Clause 12. The thermal management device of any one of clauses 1 through 11, wherein the portion of the refrigerant loop is arranged on a first side of the enclosure and the coolant loop is arranged on a second side of the enclosure opposite the first side.

Clause 13. A method of manufacturing a thermal management device with integrated refrigeration and cooling capabilities, the method including providing (i) a compressor, (ii) a shared HX, (iii) a coolant-loop HX, (iv) a coolant pump, (v) a refrigerant-loop HX (e.g., second HX 250), and (vi) an enclosure. The method includes forming a refrigerant loop by (i) fluidically coupling the compressor to the shared HX, (ii) fluidically coupling the shared HX to the refrigerant-loop HX, and (iii) fluidically coupling the refrigerant-loop HX to the compressor. The method also includes forming a coolant loop by (i) fluidically coupling the coolant-loop HX to the coolant pump, (ii) fluidically coupling the coolant pump to the refrigerant-loop HX, and (iii) fluidically coupling the refrigerant-loop HX to the coolant-loop HX; filling the refrigerant loop with a fluid refrigerant and the coolant loop with a liquid coolant; and arranging the refrigerant loop, the refrigerant-loop HX, and at least a portion of the coolant loop comprising the coolant pump; wherein the coolant-loop HX is configured to transfer heat from a battery energy storage system to the liquid coolant and the refrigerant-loop HX is configured to transfer heat from the liquid coolant to the fluid refrigerant.

Clause 14. The method of clause 13, the battery energy storage system comprises one or more battery storage cabinets containing a plurality of batteries; the coolant-loop HX is thermally coupled to the one or more battery storage cabinets such that the coolant-loop HX can transfer heat from the plurality of batteries to the liquid coolant in the coolant loop; and the refrigerant loop is configured to control a climate within the one or more battery storage cabinets.

Clause 15. The method of either clause 13 or 14, further including providing (i) a first sensor, (ii) a second sensor, and (iii) a controller. The method includes coupling the first sensor to a first portion of the coolant loop between the refrigerant-loop HX and the coolant-loop HX; coupling the second sensor to a second portion of the coolant loop between the coolant-loop HX and the coolant pump; and configuring the controller to adjust operation of a component of the refrigerant loop or the coolant loop based on sensor data from the first and second sensors. The sensor data is indicative of a thermal state of the coolant-loop HX.

Clause 16. The method of clause 15, further includes: configuring the controller to adjust the operation of the component based on a difference between (i) first sensor data indicative of a temperature or pressure of the first portion of the coolant loop and (ii) second sensor data indicative of a temperature or pressure of the second portion of the coolant loop. The first sensor is configured to collect the first sensor data and the second sensor is configured to collect the second sensor data.

Clause 17. The method of either clause 15 or 16, further includes providing a third sensor configured to collect third sensor data indicative of a relative humidity within the battery energy storage system; and configuring the controller to adjust operation of another component of the refrigerant loop or the coolant loop based on the third sensor data. The other component comprises the coolant pump, the compressor, or a fan configured to blow air across the shared HX.

Clause 18. A method of operating a thermal management system with integrated refrigeration and cooling capabilities, the method includes receiving sensor data from first and second sensors. The sensor data is indicative of a thermal state of a battery energy storage system cooled by a thermal management device comprising (i) a refrigerant loop containing a fluid refrigerant, (ii) a coolant loop containing a liquid coolant, and (iii) a refrigerant-loop HX (e.g., second HX 250) configured to transfer heat from the liquid coolant to the fluid refrigerant. The method includes adjusting operation of a component of the refrigerant loop or the coolant loop based on the sensor data from the first and second sensors. The refrigerant loop includes (i) a compressor, which is fluidically coupled to a shared HX (e.g., shared HX 206), (ii) the shared HX, which is fluidically coupled to the refrigerant-loop HX, and (iii) the refrigerant-loop HX, which is fluidically coupled to the compressor. The coolant loop includes (i) a coolant-loop HX, which is fluidically coupled to a coolant pump, (ii) the coolant pump, which is fluidically coupled to the refrigerant-loop HX, and (iii) the refrigerant-loop HX, which is fluidically coupled to the coolant-loop HX. The refrigerant loop, the refrigerant-loop HX, the shared HX, and at least a portion of the coolant loop comprising the coolant pump are contained within an enclosure.

Clause 19. The method of clause 18, further includes receiving first data from the first sensor indicative of a temperature or pressure of a first portion of the coolant loop between the refrigerant-loop HX and the coolant-loop HX. The first sensor is coupled to the first portion of the coolant loop and configured to collect the first sensor data. The method includes receiving second data from the second sensor indicative of a temperature or pressure of a second portion of the coolant loop between the coolant-loop HX and the coolant pump. The second sensor is coupled to the second portion of the coolant loop and configured to collect the second sensor data. The method further includes adjusting the operation of the component based on a difference between the first sensor data and the second sensor data.

Clause 20. The method of either clause 18 or 19, further includes receiving third sensor data from a third sensor indicative of a relative humidity within the battery energy storage system and adjusting operation of another component of the refrigerant loop or the coolant loop based on the third sensor data; or adjusting the operation of the component comprises adjusting an operating speed of the coolant pump, an operating speed of the compressor, or an operating speed of a fan configured to blow air across the refrigerant-loop HX.

Further Consideration. The specific order or hierarchy of steps in the processes disclosed herein is an illustration of example approaches. Based upon design preferences, it is understood that the specific order or hierarchy of steps in the processes may be rearranged. Some of the steps may be performed simultaneously. The accompanying method claims pre-sent elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intend-ed to mean “one and only one” unless specifically so stated, but rather “one or more.” Unless specifically stated otherwise, the term “some” refers to one or more. Headings and subheadings, if any, are used for convenience only and do not limit the invention described herein.

The predicate words “configured to,” “operable to,” and “programmed to” do not imply any particular tangible or intangible modification of a subject, but rather are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “implementation” does not imply that such implementation is essential to the subject technology or that such implementation applies to all configurations of the subject technology. A disclosure relating to an implementation may apply to all implementations, or one or more implementations. An implementation may provide one or more examples. A phrase such as “implementations” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

As used herein, the terms “determine” and “determining” encompass a wide variety of actions. For example, “determining” may include calculating, computing, processing, deriving, generating, obtaining, looking up (e.g., looking up in a table, a database or another data structure), ascertaining and the like via a hardware element without user intervention. Also, “determining” may include receiving (e.g., receiving information), accessing (e.g., accessing data in a memory) and the like via a hardware element without user intervention. “Determining” may include resolving, selecting, choosing, establishing, and the like via a hardware element without user intervention.

As used herein, the term “message” encompasses a wide variety of formats for communicating (e.g., transmitting or receiving) information. A message may include a machine readable aggregation of information such as an XML document, fixed field message, comma separated message, JSON, a custom protocol, or the like. A message may, in some embodiments, include a signal utilized to transmit one or more representations of the information. While recited in the singular, it will be appreciated that a message may be composed, transmitted, stored, received, and so on in multiple parts.

As used herein, the term “selectively” or “selective” may encompass a wide variety of actions. For example, a “selective” process may include determining one option from multiple options. A “selective” process may include one or more of: dynamically determined in-puts, preconfigured inputs, or user-initiated inputs for making the determination. In some embodiments, an n-input switch may be included to provide selective functionality where n is the number of inputs used to make the selection.

As used herein, the terms “correspond” or “corresponding” encompasses a structural, functional, quantitative and/or qualitative correlation or relationship between two or more objects, data sets, information and/or the like, preferably where the correspondence or relationship may be used to translate one or more of the two or more objects, data sets, information and/or the like so to appear to be the same or equal. Correspondence may be assessed using one or more of a threshold, a value range, fuzzy logic, pattern matching, a machine-learning assessment model, or combinations thereof.

In any embodiment, data generated or detected can be forwarded to a “remote” device or location, where “remote,” means a location or device other than the location or device at which the program is executed. For example, a remote location could be another location (e.g., an office, a lab) in the same city, another location in a different city, another location in a different state, another location in a different country, and so on. As such, when one item is indicated as being “remote” from another, what is meant is that the two items can be in the same room but separated, or at least in different rooms or different buildings, and can be at least one mile, ten miles, or at least one hundred miles apart. “Communicating” information references transmitting the data representing that information as electrical signals over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data. Examples of communicating media include radio or infra-red transmission channels as well as a network connection to another computer or networked device, and the internet or including email transmissions and information recorded on websites and the like.

What is claimed is:

1. A thermal management device with integrated refrigeration and cooling capabilities, the thermal management device comprising:
a refrigerant loop containing a fluid refrigerant and comprising (i) a compressor, (ii) a shared heat exchanger (HX), and (iii) a refrigerant-loop HX, wherein:
the compressor is fluidically coupled to the shared HX;
the shared HX is fluidically coupled to the refrigerant-loop HX; and
the refrigerant-loop HX is fluidically coupled to the compressor;
a coolant loop containing a liquid coolant and comprising (i) a coolant-loop HX, (ii) a coolant pump, and (iii) the refrigerant-loop HX, wherein:
the coolant-loop HX is fluidically coupled to the coolant pump and configured to transfer heat from a battery energy storage system to the liquid coolant;
the coolant pump is fluidically coupled to the refrigerant-loop HX; and
the refrigerant-loop HX is fluidically coupled to the coolant-loop HX; and
an enclosure containing the refrigerant loop, the refrigerant-loop HX, and at least a portion of the coolant loop comprising the coolant pump;
wherein the refrigerant-loop HX is configured to transfer heat from the liquid coolant in the coolant loop to the fluid refrigerant in the refrigerant loop.

2. The thermal management device of claim 1, further comprising a controller configured to maintain a battery cell temperature using the coolant loop but not the refrigerant loop during battery charge and discharge cycles.

3. The thermal management device of claim 1, further comprising a controller configured to maintain a battery cell temperature using the coolant loop and the refrigerant loop outside of battery charge and discharge cycles.

4. The thermal management device of claim 1, wherein:
the battery energy storage system comprises one or more battery storage cabinets containing a plurality of batteries; and
the coolant-loop HX is thermally coupled to the one or more battery storage cabinets such that the coolant-loop HX can transfer heat from the plurality of batteries to the liquid coolant in the coolant loop.

5. The thermal management device of claim 4, wherein the refrigerant loop is configured to control a climate within the one or more battery storage cabinets.

6. The thermal management device of claim 1, further comprising:
a first sensor coupled to a first portion of the coolant loop between the refrigerant-loop HX and the coolant-loop HX;
a second sensor coupled to a second portion of the coolant loop between the coolant-loop HX and the coolant pump; and
a controller configured to adjust operation of a component of the refrigerant loop or the coolant loop based on sensor data from the first and second sensors, wherein the sensor data is indicative of a thermal state of the coolant-loop HX.

7. The thermal management device of claim 6, wherein:
the first sensor is configured to collect first sensor data indicative of a temperature or pressure of the first portion of the coolant loop;
the second sensor is configured to collect second sensor data indicative of a temperature or pressure of the second portion of the coolant loop; and
the controller is configured to adjust the operation of the component based on a difference between the first sensor data and the second sensor data.

8. The thermal management device of claim 6, further comprising:
a third sensor configured to collect third sensor data indicative of a relative humidity within the battery energy storage system;
wherein the controller is configured to adjust operation of another component of the refrigerant loop or the coolant loop based on the third sensor data, wherein the other component comprises the coolant pump, the compressor, or a fan configured to blow air across the refrigerant-loop HX.

9. The thermal management device of claim 6, wherein:
adjusting the operation of the component comprises adjusting an operating speed of the coolant pump, an operating speed of the compressor, or an operating speed of a fan configured to blow air across the shared HX.

10. The thermal management device of claim 1, wherein:
the refrigerant loop further comprises another refrigerant-loop HX;
the refrigerant-loop HX is fluidically coupled to both: (i) the shared HX via an expansion valve, and (ii) the other refrigerant-loop HX via another expansion valve; and
the other refrigerant-loop HX is fluidically coupled to the compressor.

11. The thermal management device of claim 10, wherein:
the shared HX is a condenser; and
the refrigerant-loop HX is an evaporator.

12. The thermal management device of claim 1, wherein the refrigerant loop is arranged on a first side of the enclosure and the portion of the coolant loop is arranged on a second side of the enclosure opposite the first side.

13. A method of manufacturing a thermal management device with integrated refrigeration and cooling capabilities, the method comprising:
providing (i) a compressor, (ii) a shared HX, (iii) a coolant-loop HX, (iv) a coolant pump, (v) a refrigerant-loop HX, and (vi) an enclosure;
forming a refrigerant loop by (i) fluidically coupling the compressor to the shared HX, (ii) fluidically coupling the shared HX to the refrigerant-loop HX, and (iii) fluidically coupling the refrigerant-loop HX to the compressor;
forming a coolant loop by (i) fluidically coupling the coolant-loop HX to the coolant pump, (ii) fluidically coupling the coolant pump to the refrigerant-loop HX, and (iii) fluidically coupling the refrigerant-loop HX to the coolant-loop HX;
filling the refrigerant loop with a fluid refrigerant and the coolant loop with a liquid coolant; and
arranging in the enclosure the refrigerant loop, the refrigerant-loop HX, and at least a portion of the coolant loop comprising the coolant pump;
wherein the coolant-loop HX is configured to transfer heat from a battery energy storage system to the liquid coolant and the refrigerant-loop HX is configured to transfer heat from the liquid coolant to the fluid refrigerant.

14. The method of claim 13, wherein:
the battery energy storage system comprises one or more battery storage cabinets containing a plurality of batteries;
the coolant-loop HX is thermally coupled to the one or more battery storage cabinets such that the coolant-loop HX can transfer heat from the plurality of batteries to the liquid coolant in the coolant loop; and
the refrigerant loop is configured to control a climate within the one or more battery storage cabinets.

15. The method of claim 13, further comprising:
providing (i) a first sensor, (ii) a second sensor, and (iii) a controller;
coupling the first sensor to a first portion of the coolant loop between the refrigerant-loop HX and the coolant-loop HX;
coupling the second sensor to a second portion of the coolant loop between the coolant-loop HX and the coolant pump; and
configuring the controller to adjust operation of a component of the refrigerant loop or the coolant loop based on sensor data from the first and second sensors, wherein the sensor data is indicative of a thermal state of the coolant-loop HX.

16. The method of claim 15, further comprising:
configuring the controller to adjust the operation of the component based on a difference between (i) first sensor data indicative of a temperature or pressure of the first portion of the coolant loop and (ii) second sensor data indicative of a temperature or pressure of the second portion of the coolant loop;
wherein the first sensor is configured to collect the first sensor data and the second sensor is configured to collect the second sensor data.

17. The method of claim 15, further comprising:
providing a third sensor configured to collect third sensor data indicative of a relative humidity within the battery energy storage system; and
configuring the controller to adjust operation of another component of the refrigerant loop or the coolant loop based on the third sensor data, wherein the other component comprises the coolant pump, the compressor, or a fan configured to blow air across the shared HX.

18. A method of operatingflui a thermal management system with integrated refrigeration and cooling capabilities, the method comprising:
receiving sensor data from first and second sensors, wherein the sensor data is indicative of a thermal state of a battery energy storage system cooled by a thermal management device comprising (i) a refrigerant loop containing a fluid refrigerant, (ii) a coolant loop containing a liquid coolant, and (iii) a refrigerant-loop HX configured to transfer heat from the liquid coolant to the fluid refrigerant; and
adjusting operation of a component of the refrigerant loop or the coolant loop based on the sensor data from the first and second sensors;
wherein the refrigerant loop comprises (i) a compressor, which is fluidically coupled to a shared HX, (ii) the shared HX, which is fluidically coupled to the refrigerant-loop HX, and (iii) the refrigerant-loop HX, which is fluidically coupled to the compressor;
wherein the coolant loop comprises (i) a coolant-loop HX, which is fluidically coupled to a coolant pump, (ii) the coolant pump, which is fluidically coupled to the refrigerant-loop HX, and (iii) the refrigerant-loop HX, which is fluidically coupled to the coolant-loop HX; and
wherein the refrigerant loop, the refrigerant-loop HX, and at least a portion of the coolant loop comprising the coolant pump are contained within an enclosure.

19. The method of claim 18, further comprising:
receiving first data from the first sensor indicative of a temperature or pressure of a first portion of the coolant loop between the refrigerant-loop HX and the coolant-loop HX, wherein the first sensor is coupled to the first portion of the coolant loop and configured to collect the first sensor data;
receiving second data from the second sensor indicative of a temperature or pressure of a second portion of the coolant loop between the coolant-loop HX and the coolant pump, wherein the second sensor is coupled to the second portion of the coolant loop and configured to collect the second sensor data; and
adjusting the operation of the component based on a difference between the first sensor data and the second sensor data.

20. The method of claim 18, further comprising:
receiving third sensor data from a third sensor indicative of a relative humidity within the battery energy storage system and adjusting operation of another component of the refrigerant loop or the coolant loop based on the third sensor data; or
adjusting the operation of the component comprises adjusting an operating speed of the coolant pump, an operating speed of the compressor, or an operating speed of a fan configured to blow air across the shared HX.
